(19) United States
(12) Patent Application Publication
(10) Pub. No.: US 2005/0044156 A1
(43) Pub. Date: Feb. 24, 2005

(54) Verified registry

(76) Inventors: David Kaminski, Raleigh, NC (US); Reggie Strange, Cumming, GA (US)

Correspondence Address: COATS & BENNETT, PLLC, P O BOX 5, RALEIGH, NC, 27602, US

(21) Appl. No.: 10/915,616

(22) Filed: Aug. 10, 2004

Related U.S. Application Data
(60) Provisional application No. 60/497,446, filed on Aug. 22, 2003.

(51) Int. Cl. G06F 15/16

(52) U.S. Cl. 709/206

(57) ABSTRACT

An anti-spamming agent filters incoming email messages to eliminate unsolicited and unwanted email messages, particularly bulk email messages commonly known as spam. The anti-spamming agent gives all incoming mail messages a score and processes the messages based on the message score. Messages receiving a qualifying score are forwarded to the user. All other messages are either discarded or quarantined while the anti-spamming agent performs further authorization procedures, such as a challenge-response procedure. When a message from an unknown sender is received, a verified mail registry may be queried to authenticate the sender, and the mail may be processed based on the response from the verified mail registry.

This application claims priority under 35 U.S.C. § 119(e) from the following U.S. provisional application: Application Ser. No. 60/497,446 filed on Aug. 22, 2003. This application is incorporated in its entirety by reference herein.

### BACKGROUND OF THE INVENTION

The present invention relates generally to systems and methods of filtering unwanted electronic mail messages, commonly referred to as spam. Unsolicited bulk email, commonly known as spam, is a growing problem in the United States. It is estimated that spam accounts for over 60% on average of all email traffic. Consequently, an average user now has more unwanted messages than wanted ones in his or her “In Box.” The massive amount of unwanted email creates burdens, not only on end users who are forced to sift through and sort their mail, but also on network administrators and the infrastructure for carrying email. Unfortunately, the economics of the Internet encourage spammers. The cost of obtaining a list of email addresses and sending bulk email messages is extremely low. Consequently, spammers can earn a profit with response rates as low as 1 in 100,000. While there is some movement to pass legislation banning spam, such legislation is not likely to end spamming. The only viable solution to the spamming problem is a technological solution that prevents unsolicited bulk email from reaching their target.

Challenge response systems are known for filtering junk mail messages. In conventional challenge-response systems, the addresses of known mail senders are stored in either an “accept list” or a “deny list.” Mail from senders on the deny list are blocked, while mail from senders on the accept list are delivered. The mail server sends a challenge to unknown mail senders and quarantines their mail pending the outcome of the challenge. If a correct response to the challenge is received, the quarantined mail is delivered and the sender is added to the accept list. If a correct response to the challenge is not received within a predetermined time, the mail is discarded and the sender may be added to the deny list. Challenge-response mail systems are described in U.S. Pat. Nos. 6,199,102 to Cobb; 6,112,227 to Heiner; 6,546,416 to Kirsch; and 6,691,156 to Drummond et al, which are incorporated herein by reference.

### SUMMARY OF THE INVENTION

The present invention comprises a verified mail registry for a challenge-response mail system to avoid challenges to mail senders that can be verified by a trusted authority. Mail senders can establish an account with the verified mail registry. A registered mail sender can create one or more temporary codes for insertion into outgoing mail messages, and register the temporary codes with the verified mail registry. The mail server for a recipient of a message can verify that the sender is a registered mail sender by sending a verification request containing the temporary code and the sender's identifying information, e.g., sender's address or account information, to the verified mail registry for verification. The mail server will not challenge a mail sender whose registration with the verified mail registry can be confirmed.

The present invention further comprises a verified registry for web servers to prevent unauthorized data mining. Web users can establish an account with the verified web registry. A web server can query the web registry to determine whether a requestor is a registered web users. Registered web users may be given access to data, or may be given data in a specified form. Unregistered users may be denied access to information, or given information in a form different than registered users. For example, email addresses may be provided in graphic form to unregistered users, and in a text form to registered users.

### BRIEF DESCRIPTION OF THE DRAWINGS

FIG. 1 illustrates an exemplary computer network including mail clients and mail servers for delivering electronic mail messages between computers.

FIG. 2 illustrates the basic elements and interoperation of mail clients and mail servers according to one exemplary embodiment of the invention.

FIG. 3 illustrates the basic elements of an exemplary anti-spamming agent for the mail servers.

FIG. 4 illustrates an exemplary procedure used by the anti-spamming agent for filtering and scoring incoming mail messages

FIG. 5 illustrates an exemplary message scoring procedure used by the anti-spamming agent.

FIG. 6 illustrates an exemplary auto-authorization procedure implemented by the mail servers and mail clients.

FIG. 7 illustrates an exemplary pre-authorization procedure implemented by the mail servers and mail clients.

FIG. 8 illustrates an exemplary loop prevention procedure implemented by the mail clients and mail servers.

FIGS. 9 and 10 illustrate an exemplary verification procedure using a verified mail registry.

FIG. 11 illustrates an exemplary communication network including a web registry to verify user's trying to access a web server.

### DETAILED DESCRIPTION OF THE INVENTION

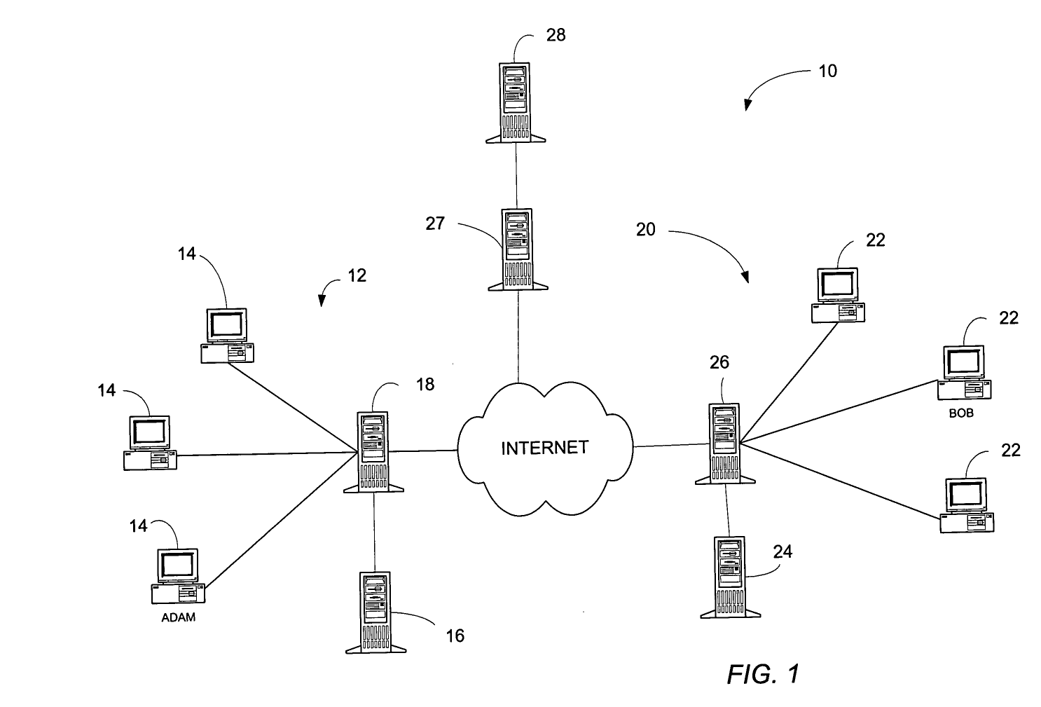

FIG. 1 illustrates a computer network 10 in which the present invention may be implemented. The computer network 10 comprises first and second local area networks (LANs) 12 and 20. The first LAN 12 comprises a plurality of client machines 14 and a mail server 16 connected to a gateway 18. The second LAN 20 likewise comprises a plurality of client machines 22 and mail server 24 connected to a gateway 26. Network 10 further includes a registry server 28 connected to a gateway 27. The function of the registry server is to provide a registry for email users and to provide verification services to mail servers to facilitate email delivery without inconvenience to the mail sender. Gateways 18, 26 and 27 provide connection to the Internet or other internet or intranet 24, and provide a firewall to prevent unwanted intrusion to LANs 12 and 20, and registry server 28.

Each client machine 14, 22 may comprise for example a personal computer, such as a desktop computer, laptop computer or notebook computer, Internet appliance, or pervasive computing device, such as a palm computer, personal digital assistant (PDA), or mobile telephone. The client machines 14, 22 may include any known operating system, such as IBM OS/2, Windows 9x, Windows NT, Windows 2000, Windows XP, Windows CE, Palm OS, Macintosh OSX, Unix, or Linux. The client machines 14, 22 typically include a suite of Internet applications or tools, such as a web browser and mail client. The mail client is sometimes referred to as a mail user agent (MUA). Common web browser applications include Netscape's Navigator, Microsoft's Internet Explorer, and Apple's Safari, all of which include support for Java Virtual Machine (JVM) and various plug-ins or helper applications. Common mail clients include Microsoft's Outlook, Outlook Express and Entourage, Lotus Notes, and Eudora. Mail servers 16, 24 comprise a computer, such as a workstation computer, minicomputer, or desktop computer, including a server operating system, such as Microsoft Small Business Server, Macintosh OSX Server, Unix, or Linux. Servers 16, 24 further include a mail server application, such as sendmail or Microsoft Exchange.

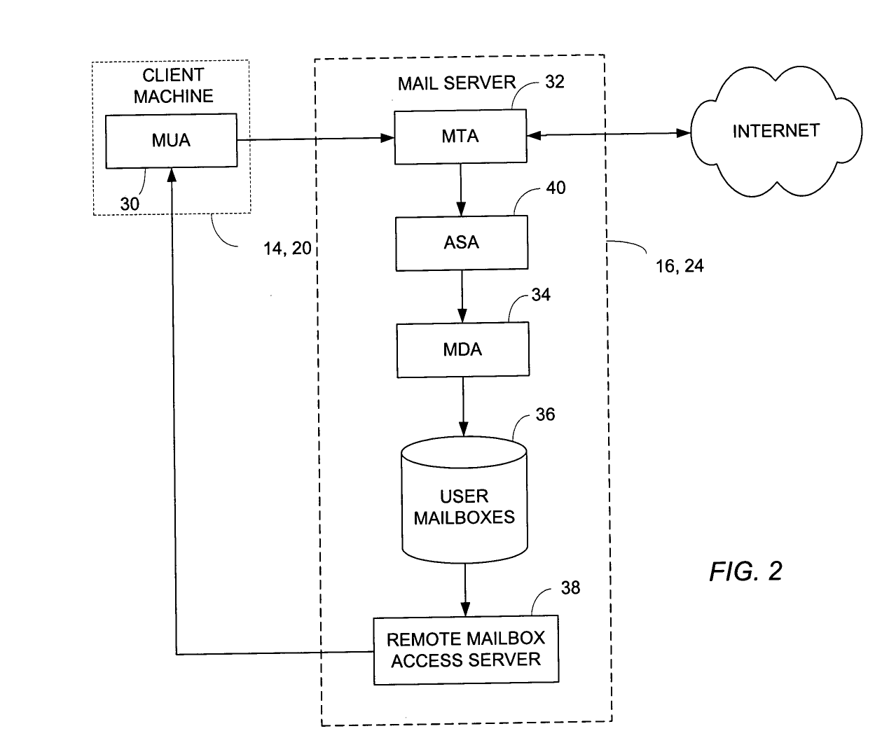

FIG. 2 illustrates the entities typically involved in the delivery of email form one computer to another. Email functions can be divided into five logical parts: a mail user agent (MUA) 30, a mail transport agent (MTA) 32, a mail delivery agent (MDA) 34, a message queue 36, and a remote mailbox access server 38. The MUA 30 is typically part of a mail client application on a client machine 14, 20. The MTA 32, MDA 34, message queue 36 and remote mailbox access server 38 are part of the mail server application on mail servers 16, 24. The MUA 30 handles all tasks related to the creation and addressing of outgoing mail messages, and retrieves incoming mail messages from a mail server 16, 24. The MTA 32 manages the process of transferring mail between computers and the MDA 34 delivers mail to individual user mailboxes in the message queue 36. The message queue 36 is a local file system on a hard disk or other memory device containing individual user mailboxes for storing incoming and outgoing mail messages. The remote mailbox access server 38 provides the user access to mail stored in the user mailbox using a remote mailbox access protocol, such as IMAP or POP3. According to the present invention, mail servers 16 and 22 further include an anti-spamming agent 40, which may be integrated with the MTA 32 and/or MDA 34. The function of the anti-spamming agent 40 is to filter unwanted bulk emails from the incoming mail.

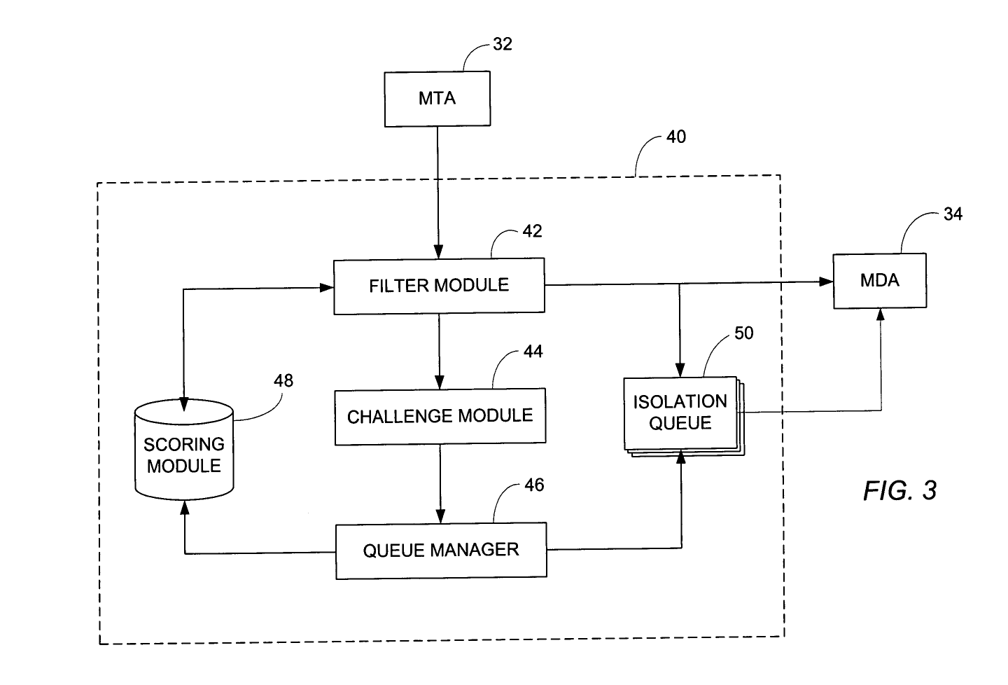

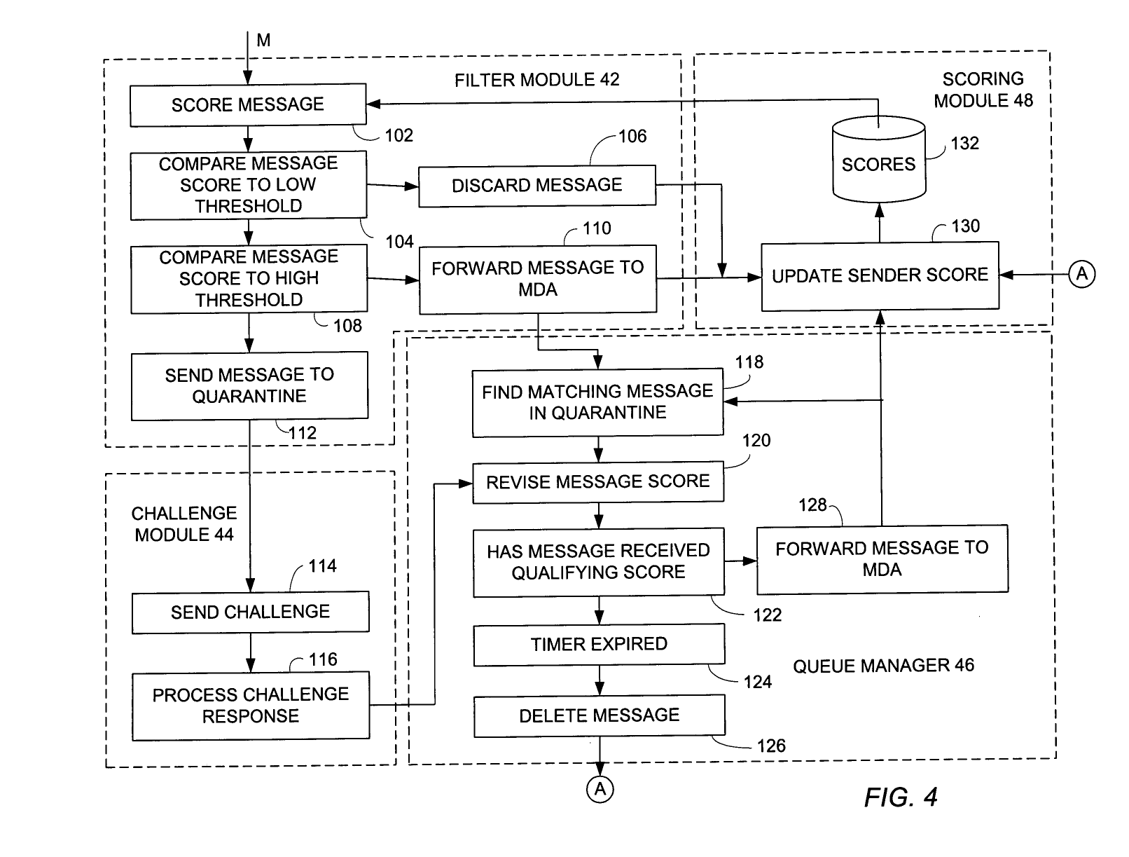

FIG. 3 illustrates the basic elements of the anti-spamming agent 40. The anti-spamming agent 40 includes a filter module 42, a challenge module 44, a queue manager 46, a scoring module 48 and an isolation queue 50. The filter module 42 receives incoming mail messages, scores the messages, and processes the messages depending on the message score. The filter module 42 passes messages receiving a qualifying score to the MDA 34 for delivery to the user's mailboxes and discards mail messages that receive a disqualifying score. Messages receiving a score between the qualifying and disqualifying score are quarantined in isolation queue 50. The challenge module 44 issues challenges to senders of mail messages sent to the isolation queue 50 and processes any responses. The purpose of the challenge is to give the sender an opportunity to take some action to ensure delivery of his or her mail message. The queue manager 46 manages mail messages in the isolation queue. It may reevaluate message scores of quarantined messages responsive to certain events, and delete messages that fail to receive a qualifying score within a predetermined time period. The scoring module 48 is responsible for tasks related to maintenance of scores used to compute the message score. A sender's score is given to all known sender addresses and stored in a database 132 (FIG. 4). The sender's score is used by the filter module 42 to compute message scores for incoming messages. The scoring module 48 updates the senders' scores responsive to both favorable and unfavorable events. In addition to sender's scores, the scoring database may store address patterns, domains, and domain patterns with associated scores that can be used to compute message scores for incoming mail messages.

The following discussion explains the operation of the anti-spamming agent 40. For purposes of discussion, it is assumed that a first user at a client machine 14, who is referred to herein as Adam, is sending mail to a second user at a client machine 20, who shall be referred to as Bob. Mail server 16 is Adam's mail server, and mail server 24 is Bob's mail server. The basic operations of the mail servers 16, 24 include scoring and filtering unwanted bulk email, pre-authorization and auto-authorization to minimize inconvenience to users, and detection of challenge messages to prevent endless challenge loops. In another embodiment, the mail servers 16, 24 may optionally perform a verification procedure prior to filtering. If the incoming mail is from a verified sender, the incoming message can be processed normally without filtering.

### Scoring and Filtering Unwanted Messages

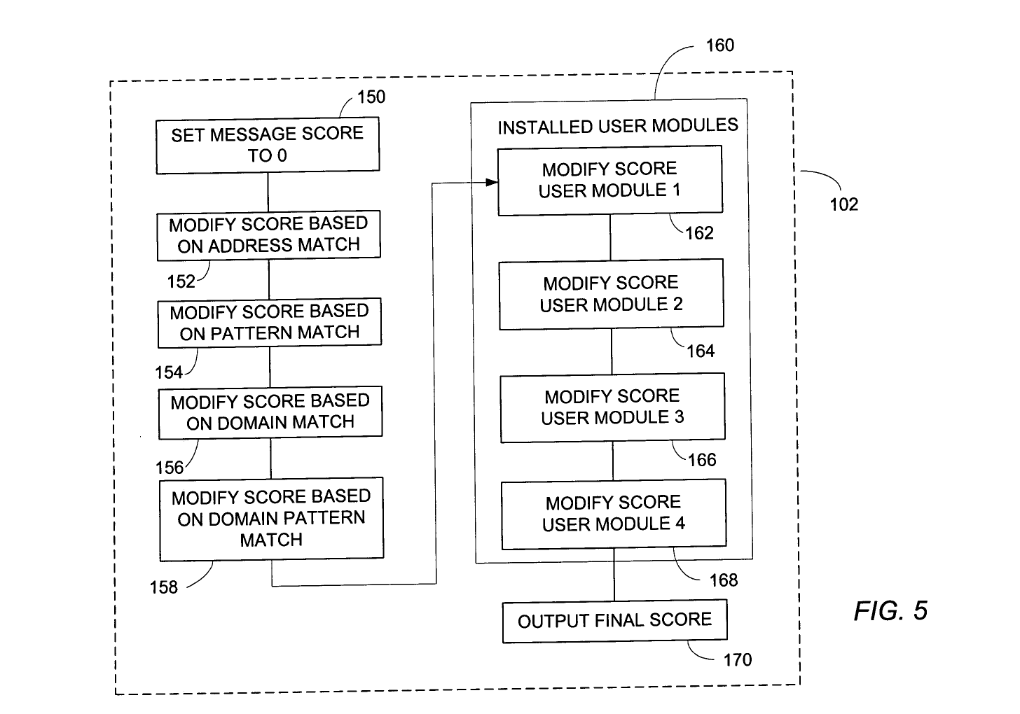

FIG. 4 illustrates how incoming mail messages are processed by mail servers 16, 24. Incoming mail M is input to the anti-spamming agent 40 by the MTA 32. The filter module 42 generates a score for each incoming mail message (block 102) based at least in part on the sender's address and compares the computed score to one or more thresholds (blocks 104, 108). Other parameters, such as the message content, may also be considered in generating the message score. The scoring routine is shown in FIG. 5 and is described in more detail below. The exemplary embodiment has a positive threshold for qualifying mail and a negative threshold for disqualifying mail. The thresholds may be set by the user. If the computed score is below the negative threshold (block 104), the filter module 32 discards the message (block 106). If the computed score is greater than the positive threshold (block 108), the filter module 42 passes the incoming message to a MDA 34 (block 110), which delivers the message to the user's mailbox in the message queue 36. Mail messages receiving a score between the thresholds are quarantined (block 112). Quarantined messages are subject to further processing by the challenge module 44 and queue manager 46 as described below. The message remains in the isolation queue until a qualifying score is obtained, or it is deleted from the system after remaining in the isolation queue for a predetermined time period. If the message achieves a qualifying score, it is forwarded to the MDA (block 128). If the message fails to achieve a qualifying score, it is deleted from the isolation queue (block 126).

Processing of incoming mail messages ends with the updating of the scoring database by the scoring module 48 (block 130). As note above, the scoring database stores the email addresses of mail senders and a corresponding sender's score for each address. The sender's score is used to compute the score of incoming messages. If a mail message is delivered (block 110 or block 128), the message score is incremented by a predetermined amount, which may be a fixed amount or by a user configurable amount. Similarly, if a mail message is discarded (block 106) or deleted (block 126), the message score is decremented by a predetermined amount, or by a user configurable amount. The final message score is then assigned to the sender and stored in the scoring database as the sender's score. If the sender's address already exists in the scoring database, the sender's score is modified to be equal to the final message score for the incoming mail message. If the sender's address does not exist in the scoring database, the sender's address is added to the database and initialized to be equal to the final message score of the incoming mail message.

When a message is quarantined, the challenge module 44 sends a challenge message to the sender (block 114) notifying the sender that the message has been quarantined. The challenge message includes instructions on how to improve the quarantined message's score so that the sender can take appropriate action to ensure final delivery of his or her message. The sender of the quarantined message may attempt to improve the score of his or her message by sending a correct response to the challenge. The challenge module 44 processes any responses to the challenge and determines if a correct response is received (block 116). Challenge responses may consist of replying to an e-mail question, completing an online form, or other similar action designed to ensure the sender is not a computer, and therefore probably not a spammer. As will be described in more detail below, the challenge message may include a special header so that other anti-spamming agents can identify the notification message as an auto-generated message and not send a challenge in response to the challenge message. Additionally, if the filter module detects authorization-codes in the sender's original message, the authorization code may be sent in the reply in a special authorization code header, as discussed in more detail below.

If a sender provides a correct response to the challenge message, the queue manager 46 will reevaluate the message score (blocks 120, 122). For example, the queue manager 46 may add a user-configurable number of points to the existing message score (block 120) and compare the new score to the positive threshold (block 122). The quarantined message remains in the isolation queue until it receives a qualifying score (above the positive threshold), or until a timer expires (block 124). If the message receives a qualifying score before the timer expires, the queue manager 46 passes the message to the MDA 34 (block 128). If the timer expires before a qualifying score is received, the queue manager 46 deletes the message (block 126).

Whenever a message is delivered to the MDA 34, the queue manager 46 checks for other quarantined messages from the same sender in the isolation queue (block 118). The qualifying message's score may be added to any quarantined messages having the same address as the qualifying message (block 120). The queue manager will pass any quarantined message that obtains a qualifying score (block 122) to the MDA 34 (block 128) as previously described. Alternatively, the queue manager 46 may simply forward any messages with matching addresses to the MDA 34.

FIG. 5 illustrates an exemplary message scoring procedure that may be implemented at block 102 of FIG. 4. An incoming e-mail starts with a score of 0 (block 150). The sender's address is first determined from the mail message headers. In the case of multiple headers (i.e. from, reply-to, return-path) with different addresses, each address may optionally be scored and the higher (or lower score) may be used to determine the message score. The scoring starts by looking for an exact match on the address in the database 132, which may comprise an individual user database or alternatively an enterprise database for corporate users (block 152). If an exact match is found, the score of the matching address is added to the current message score. The address is then compared against any e-mail patterns in the user's database (block 154) (i.e. *offers*@*, *@bestoffers.com). If a match is found, the pattern's score is then added to the current score. The domain part of the sender's address is then compared to domains in the user's database (block 156). If a match is found, the domain's score is then added to the current message score. The domain part of the address is then compared to domain patterns in the user's database (block 158) (i.e. *offers.com, *.emailmarketing.com, *offers*). If a match is found, the score of the domain pattern is added to the current message score.

After the four address comparisons are made, optional user modules (block 160) are called sequentially and the output score of each module is added to the current message score. Modules 160 have the capability of examining the full message body and headers and returning a score based on any conceivable criteria. Some modules, for example, might compare the originating mail server to a list of known spam servers. Others might look for keywords in the message body and generate a score based on their frequency. Each user module 160 examines the incoming mail message and modifies the message score (blocks 162-168) and the final score is output (block 170).

### Auto-Authorization

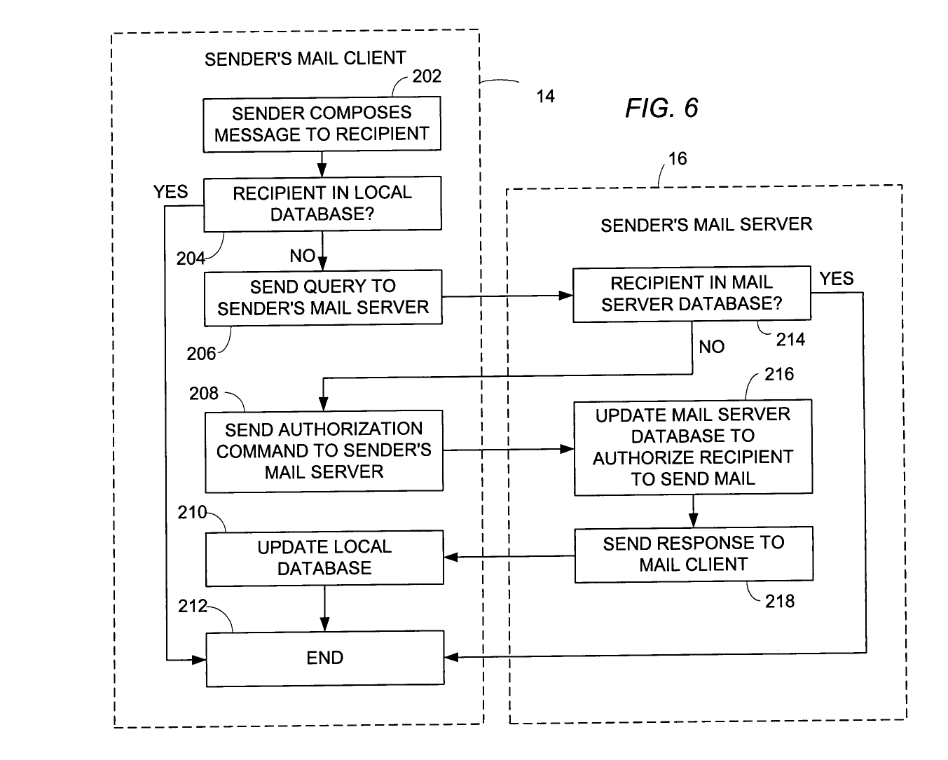

FIG. 6 illustrates an exemplary auto-authorization procedure for automatically authorizing a mail server to receive mail from a designated sender. The procedure may be used in combination with the challenge-response system described in FIG. 4 or with other challenge-response systems. It is assumed that Adam wants to authorize persons to whom Adam sends mail. Auto-authorization lessens the inconvenience with whom Adam initiates communication. In this example, the Adam's mail client 14 automatically authorizes the Adam's mail server 16 to accept mail message from anyone to whom Adam sends a message.

Adam composes a standard e-mail message in an email client (block 202). The email client may be an intelligent email client that keeps a local database of all addresses that Adam has authorized and only perform auto-authorization if it knows the recipient of the newly composed message has not previously been authorized (block 204). Thus, if the recipient of the new message is already in the local database, the auto-authorizing procedure ends (block 212). Auto-authorizing a recipient who is already authorized, however, will cause no problems and will simply be ignored by the sender's mail server 16.

If the recipient is not in the local database, or if Adam's mail client doesn't use have a local database, Adam's mail client 14 sends a query to Adam's mail server 16 (block 206). The purpose of the “query” is to determine if the recipient is authorized to send messages to Adam. The query contains information to identify the message as a query, Adam's address, and the recipient's address. The mail server 16 preferably maintains a list of persons authorized to send mail to Adam. Persons authorized to send messages may be identified in an explicit “accept list,” or may be identified as those senders stored in the scoring database with a qualifying score. The mail server 16 determines if Bob is authorized to send mail messages to Adam (block 214) and sends a reply to the query back to Adam's mail client indicating whether the recipient is authorized. In some mail server applications, the addresses of authorized senders may be stored in an “accept-list.” In mail server applications that employ some form of scoring system as described above, a sender is considered authorized if the sender's score is above the qualifying threshold used by the mail server. If the recipient is authorized, the procedure ends (block 212).

If the recipient is not currently authorized, Adam's mail client sends an authorization command to Adam's mail server (block 208). The authorization command contains information identifying the message as an authorization command, Adam's account and password, and the recipient to be authorized. If the recipient is not already authorized and the authorization message contains a valid user's account and password, the mail server 16 takes appropriate action (dependent on the specifics of the anti-spam software) to ensure the specified recipient is authorized to send to Adam's mail account (block 216). In some mail server applications, the mail server 16 may simply add the recipient's address to an “accept list” containing the addresses of authorized mail senders. In other mail server applications that employ a scoring system as described above, the mail server 16 may give the sender a score that ensures any mail messages from the sender will be authorized. The mail server 16 sends back an affirmative response (block 218) (or negative in the event of password errors) so that the mail client 14 knows the auto-authorization was successful. For non-successful authorizations, the mail client 14 may want to notify the user so the user can take appropriate action. If the recipient is currently authorized, auto-authorization is not required and the mail server 16 will ignore the authorization command, but may send a positive acknowledgement to Adam's mail client 14 (block 218). In this case, no further action is required by the mail server 16 to ensure the recipient can successfully reply to the sender. Intelligent mail clients will update the local database (block 210) responsive to the acknowledgement from the mail server 16.

### Pre-Authorization

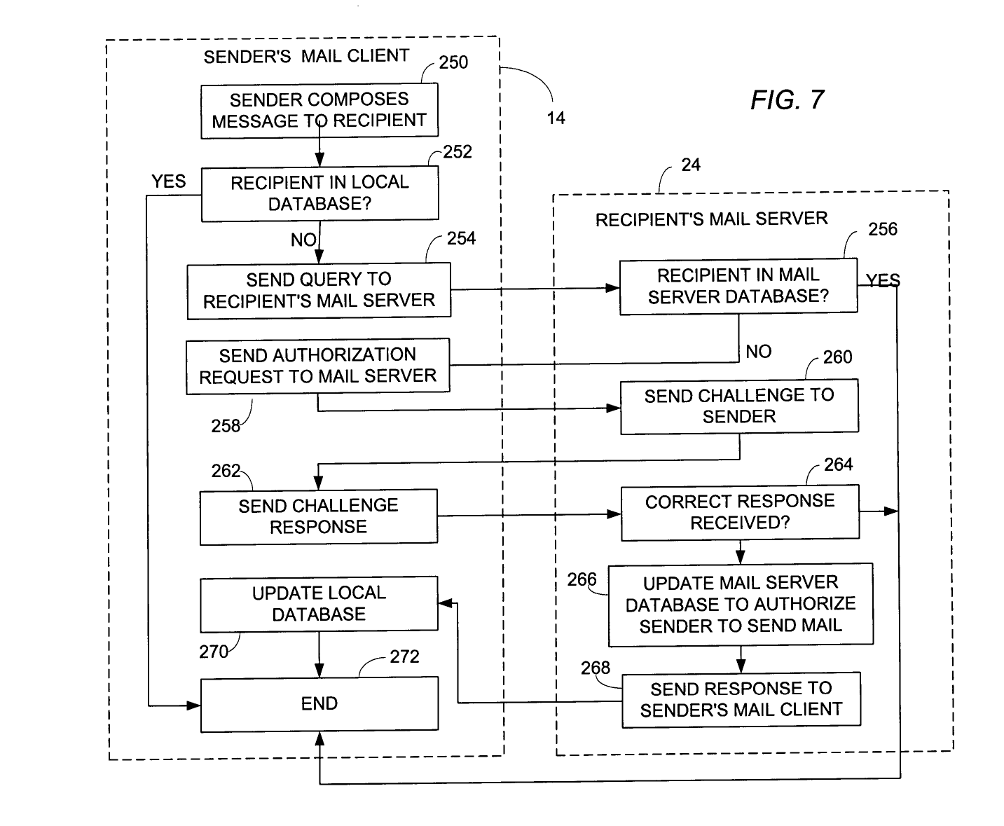

FIG. 7 illustrates a procedure that allows Adam to register as an authorized sender with Bob's mail server so that Adam can send messages to Bob. The procedure may be used in combination with the challenge-response system described in FIG. 4 or with other challenge-response systems.

Adam composes a standard e-mail message in a mail client 14 (block 250), which is addressed to Bob. Adam's mail client 14 may optionally keep a local copy of all addresses for which Adam has been authorized and perform pre-authorization only if it knows the recipient has not previously authorized Adam (block 252). Pre-authorization for a recipient who has already authorized the user will cause no problems and will simply be ignored by the recipient's mail server. If Adam is already authorized to send mail messages to Bob, pre-authorization is not required and no further action is required by Adam's mail client 14 to ensure delivery of the Adam's messages to Bob (block 272).

If Adam has not previously been authorized to send messages to Bob, Adam's mail client 14 sends a query to the Bob's mail server 24 (block 254). The query message contains information to identify the message as a query message, Adam's address, and the recipient's address, which in this example is Bob's address. The purpose of the “query” command is to determine if Bob's mail server is authorized to receive messages for Bob from Adam. Adam's mail client then waits for a response from Bob's mail server 24.

Bob's mail server 24 determines whether it is authorized to receive mail for Bob from Adam (block 256). In some mail server applications, the addresses of authorized senders will be stored in a “accept list.” In mail server applications that employ some form of scoring system as described above, a sender is considered authorized if the sender's score is above the qualifying threshold used by the mail server 24. If Adam is currently authorized, Adams' mail client 14 is notified and the procedure ends (block 272). If Adam is not currently authorized, Adam's mail client 14 will be notified and will send an authorization request to the Bob's mail server 24 (block 258). The authorization request contains information identifying the message as an authorization request, Adam's email address, and may specify a preferred challenge method. Challenge methods are preferably standardized and will relate to authorization schemes such as answering a question or completing an online form that are not likely to be completed successfully by a non-human sender. If the preferred challenge method is not supported or not available for Bob's account, Bob's mail server 24 may reply with a negative response. It is then up to the Adam's mail client to resend the authorization request to request a different challenge method as Bob's mail server 24 simply responds and considers the matter closed. The mail client may not support all current authorization schemes and can send additional authorization requests until one is found that is supported by Bob's mail server. If none are found, the Adam's mail client 14 will display an appropriate message to inform Adam that pre-authorization has failed.

If Adam's mail client 14 sends an authorization request that is supported by Bob's mail server 24, Bob's mail server 24 replies with a challenge message (block 260). The contents of the challenge message will depend on the type of challenge requested. For example, if Adam's mail client requested a text-based question, the challenge message will include a text-based question in the data portion of the challenge message. Adam's mail client 14 would then present the question to Adam and send Adam's challenge response back to Bob's mail server 24 (block 262). Each challenge method will have a different mechanism for authorization but no matter the scheme, Adam's mail client 14 will take appropriate action (i.e. displaying an error message to the user, ask to try again, etc.) if the response to the authorization is not successful. To successfully complete the authorization procedure, Adam must send a correct response to the challenge. If the response to the challenge is not correct, the authorization procedure fails and the process ends (block 272). The mail server may if desired send a challenge reply message to Adam's mail client indicating Adam failed the challenge, and may also allow Adam a predetermined number of responses before Bob's mail server 24 locks out preauthorization requests from Adam's address. If Adam sends a correct response to the challenge, Bob's mail server 24 may send a positive acknowledgement.

Upon a successful completion of the challenge, Bob's mail server 24 will take the necessary actions to ensure that Adam is authorized to send mail messages to Bob (block 266). On some systems, this would entail adding Adam to an “accept list.” In the system shown in FIG. 4 and described above, Adam's address may be added to a database with a positive score that satisfies the qualifying threshold, or Adam's current score may be increased to give Adam a positive score that satisfies the qualifying threshold. A positive response is sent back to Adam's mail client (block 268) to indicate the successful completion of the authorization procedure. An intelligent mail client will then update its local database responsive to the action taken by Bob's mail server (block 270).

### Endless Challenge Prevention

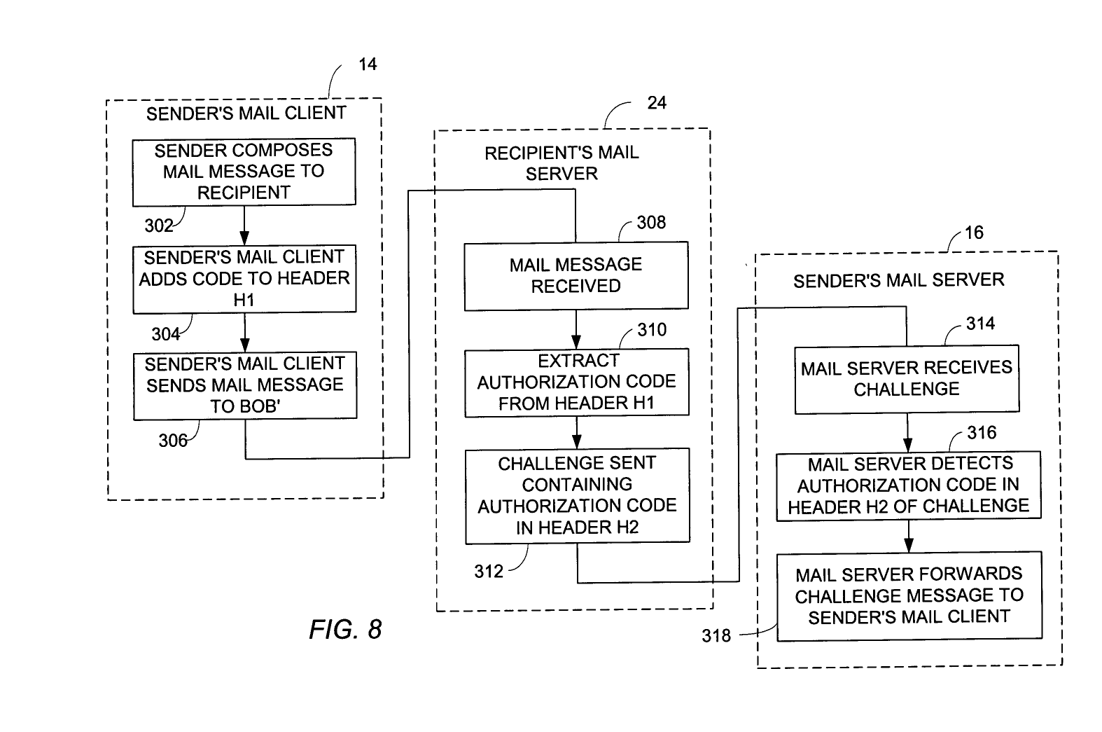

FIG. 8 shows a procedure to prevent endless challenges in systems that employ a challenge-response scheme to thwart spammers. If, for example, Bob's mail server 24 sends a challenge to Adam's mail server 16, the procedure in FIG. 8 would prevent Adam's mail server 16 from challenging the challenge. Endless challenges are prevented by use of a special authorization code in messages.

As shown in FIG. 8, Adam composes a standard mail message to Bob in a mail client 14 (block 302). Adam's mail client 14 inserts an authorization code into a first predetermined location, denoted as H1, in the message header (block 304). The authorization code acts as a password that, when inserted into a reply message, allows the reply messages to pass through Adam's mail server 16 without prior authorization. After inserting the authorization code into the outgoing message, Adam's mail client 14 sends the message (block 306) which ultimately reaches Bob's mail server 24 (block 308).

It is assumed in this example that Adam is not previously authorized to send messages to Bob so Bob's mail server 24 initiates the challenge-response process. Bob's mail server 24 looks for and finds the authorization code in a first predetermined location in the message header H1 and extracts this code (block 310). Bob's mail server 24 generates a challenge and sends the challenge to Adam (block 312). Bob's mail server 24 inserts Adam's authorization code in a second predetermined location, denoted as H2, in the header of the challenge message. Bob's mail server 24 quarantines the original message and waits for a reply to the challenge.

Adam's mail server 16 receives the challenge message (block 314) but does not recognize the sender of the challenge. Adam's mail server 16 then looks for an authorization code in the message header H2 (block 316). The authorization code extracted from the challenge message is compared to Adam's authorization code. If it is a match, the challenge message is delivered to Adam's mail client 14 as if it was from an authorized sender (block 318). If the authorization code does not match, the message would be treated like any other non-authorized message.

### Verified mail registry

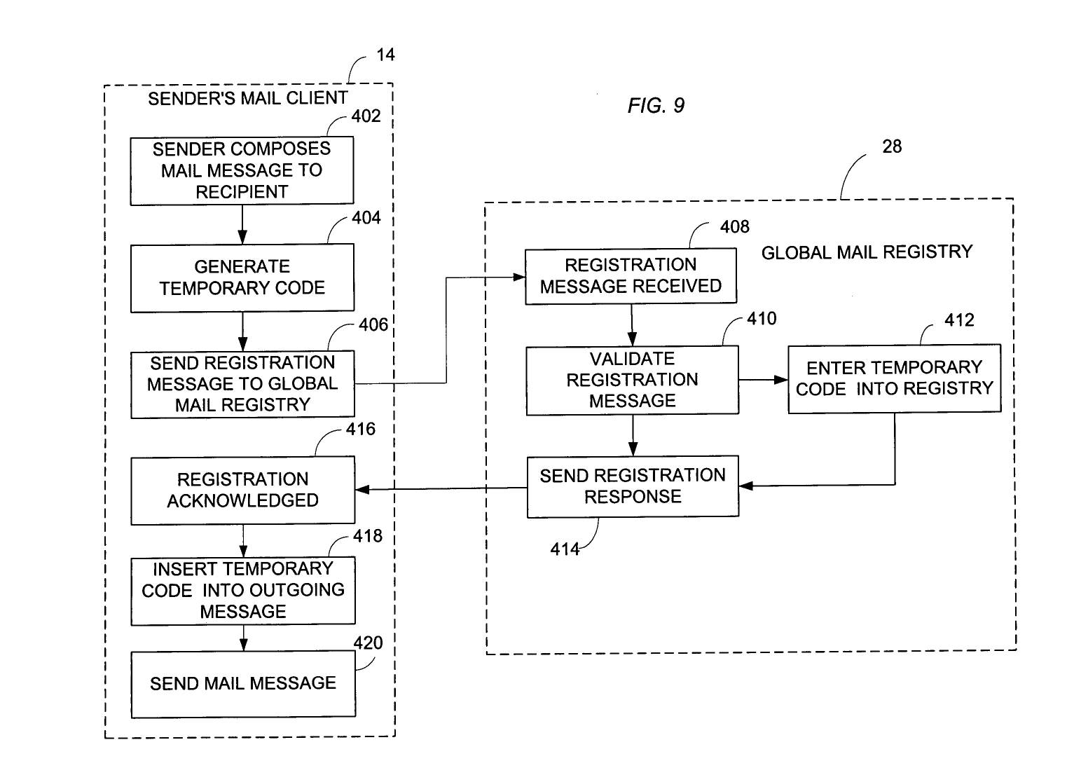

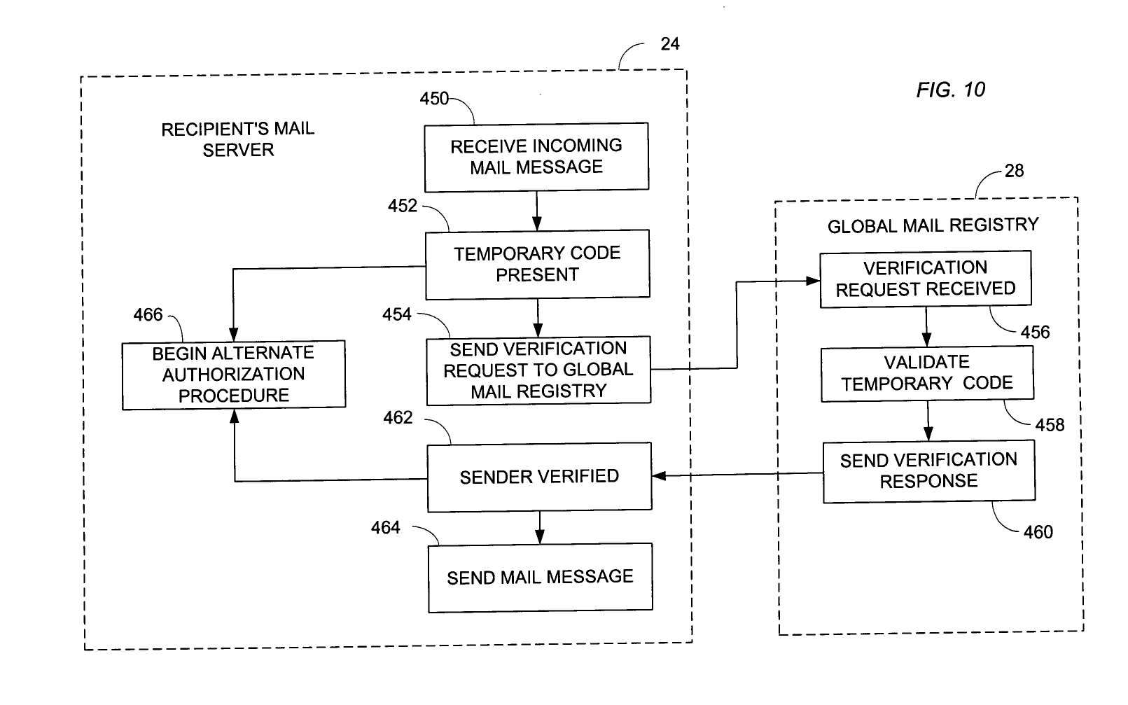

FIGS. 9 and 10 illustrate an alternate system for preventing spam that employs a mail registry maintained by a trusted party. The verified mail registry may be used in conjunction with or as an alternative to the challenge-response systems described above, or with conventional challenge-response systems. In a challenge-response system (CRS), every time a sender sends an initial message to a recipient, the sender must complete an authorization process that can be as inefficient as a challenge response or as quick as a pre-emptive authorization discussed above. In either case, a new user first establishing service on the Internet will have to authorize himself/herself with every other person with whom he/she typically exchange messages. Currently, CRSs are scarce, so this will be a minor occurrence. However, as challenge-response systems become more common, users will find themselves authorizing a large number of times. Also, anyone changing email addresses will have to obtain authorization for the new address. The verified mail registry provides a method to avoid the inconveniences associated with conventional CRSs by establishing a trusted agent that authenticates all mail messages.

The verified registry includes a registry server 28 that maintains a database of registered users that have agreed to use email under certain terms that include an agreement not to use email for delivery of unsolicited bulk email. A trusted agent operates maintains the registry server 28, establishes uniform standards and policies for email usage, and polices compliance with established standards. The trusted agent may sanction users that violate the established standards. If registered users repeatedly violate the established standards, the trusted agent may suspend or cancel the users account.

Every user having an account with the verified mail registry is assigned a master code that is known only to the user and the trusted agent. The master code is equivalent to a secret key for cryptographic algorithms and may be generated in the same manner. Key generation algorithms are well-known in the art and are not therefore described herein. The master code is stored in the registry database along with the user's account number, email address, and possibly other identifying data. The verified mail registry may store the user name and mailing address or other contact information for billing purposes and policing activities.

A registered user can create one or more temporary codes for insertion into outgoing mail messages, and register the temporary codes with the verified mail registry. The recipients of a message sent by a registered mail sender can verify that the sender is a registered user by sending a verification request containing the temporary codeword and sender's address extracted from the incoming mail message to the verified mail registry for verification. A registry server 28 compares the temporary code and address to entries in the registry database and sends a reply to the requester indicating whether the sender is a registered mail sender. The incoming mail message will be processed by the recipient's mail server based on the response from the verified mail registry.

FIG. 9 illustrates the interaction between a mail delivery system, which could be either a mail client or a mail server, and the registry server. The following discussion assumes that the mail delivery system is a mail client. The mail sender, Adam, composes a message to Bob (block 402) and transmits the mail message to Bob. The mail client 14 creates a temporary code for insertion into the outgoing mail message (block 404). This temporary code may comprise for example an arbitrary text string composed of various characters to make a unique and difficult to guess temporary code. The temporary code could also be derived by inputting the message into a hashing function. The temporary code may be generated “on-the-fly” at the time the outgoing message is created and sent, or may be pre-computed and stored in memory for use in multiple mail messages. In the embodiment shown in FIG. 9, the temporary code is created “on-the-fly” and is used for a single mail message.

The mail client 14 sends a registration message containing the user's account, master code, and temporary code to the registry server (block 406). The registration message is preferably encrypted using a public key cryptographic algorithm to prevent eavesdropping. The registration message may contain a count value that that specifies the number of times that the temporary code may be used, or a time value that specifies how long the temporary code can be used. The time value may be a absolute time (3:00 PM the following Friday), or a relative time, (three days from the date of the registration message). The registry server 28 receives and validates the registration message (block 408, 410). If the user's account and master code are valid, the registry stores the temporary code in the verified mail registry (block 412). The registry server sends a verification response to the sender to indicating the results of the validation process (block 414). The mail client 14 then places the temporary code in a special registry header field and the user's account in a second registry header field (block 418) and sends the mail message (block 420).

FIG. 10 illustrates the interaction between the mail server 24 for the recipient of the mail message and the verified mail registry. When a mail server 24 receives a message that is not from an authorized sender, the existence of the special registry header informs the mail server 24 that the sender is part of the verified mail registry system (block 452). The mail server 24 extracts the account information and temporary code from the incoming message, establishes communications with the registry server 28, and sends a verification request containing the sender's account and temporary code to the registry server 28 (block 454). The registry server 28 receives the verification request (block 456) and validates the message by comparing the temporary code and account extracted from the verification request to the codes and account in the verified mail registry (block 458). If the sender's account and the temporary code from the verification request match what is stored in the verified mail registry, the registry server 28 sends back an affirmative response to the verification request (block 460). The mail server 24 evaluates the verification response (block 462) and forwards the message to the MDA 34 for delivery to the recipient if a positive response is received (block 464). Because of the special registry header, the sender is not inconvenienced with having to respond to a challenge, or having the message quarantined or deleted. If the response from the registry server is negative, the mail server 24 treats the message as a normal unauthorized message and may invoke an alternate authorization procedure, such as a challenge-response procedure (block 466).

The verified mail registry may be centrally managed much in the same way domain names and key certificates are managed. To be included in the verified mail registry, an individual will have to present sufficient credentials to a member of the registry organization to assure the registry organization that the individual is who they say they are and can be traced back in the event they abuse their inclusion in the verified mail registry. Registry organizations will charge for their services and prevent abusers from returning by tracking abuse by credit card numbers, driver's license numbers, or other such identifying numbers that cannot be easily duplicated after being kicked out of the registry database. This would prevent spammers from creating numerous accounts in the verified mail registry. By keeping spammers out of the verified mail registry, mail servers can safely authorize any sender who has a valid account with the registry. The registry can also put limits on how many e-mail messages a registered user can send in a day. Users may subscribe to different levels of service allowing a different number of daily email messages. The different service levels would enable the registry to serve the needs of large, medium, and small businesses, as well as the needs of consumers. Since legitimate users would unlikely send more than a hundred e-mails in any given day, limiting the amount of entries an account can make will limit spammers from sending out mail even if they do infiltrate the registry. The registry will increase the daily limit for users who have not had complaints against them. The result is that the daily limit for legitimate users can be increased over time.

Verified mail registry authorization is the process by which a CRS accepts a message without the normal authorization procedures on the “advice” of a trusted outside party, the verified mail registry. When a message delivery systems sends a message, the message system uses the sender's account and master code to contact the verified mail registry and store the temporary code. The message delivery system then puts the sender's account and the temporary code in special headers and sends the message. If a message is sent to a list, the same password hash is sent to each recipient. The verified mail registry will delete entries after a specified period of time (typically 3 days).

Since the master code is required to add an entry to the registry database and the master code is not known to anyone except the user and the trusted agent, it becomes nearly impossible for a spammer to hijack the account of a verified member of the registry. Even if a master code were compromised, the daily entry limit would prevent the spammer from being able to send any worthwhile amount of messages.

### Verified Server Registry

The concept of the verified mail registry may also be used to prevent data mining by spammers and other persons harvesting email addresses, or other types of data. Spammers frequently use web crawlers to harvest email addresses from usenet postings, DNS listings, or web pages where users' email addresses are frequently posted. The web crawlers are automated programs that browse the Internet and extract information from visited sites. Web crawlers can be programmed to recognize email addresses at visited sites. To prevent harvesting of email addresses by spammers, it is common for usenet servers, DNS servers, and other web servers to provide email addresses in the form of a graphic, which at present is not recognized by web crawlers harvesting email addresses. Providing email addresses as a graphic is somewhat inconvenient for legitimate users, who must type the email address into a mail client or other application in order to send messages or communicate the relevant data. It would be preferable if the email addresses could be provided in text form for easy copying or associated with a hypertext link that automatically launches the user's email application and fills in the destination address.

The same techniques used to protect email addresses from spammers can be used to protect other types of data from data miners. The fundamental idea is that data may be provided in one form to unverified users, and in a different and more convenient form for verified users. Also, technological restraints on use of data may be imposed on unverified users. For example, digital rights management (DRM) technology may be used to restrict how digital data is used. Unverified users may be allowed access to digital data with certain restrictions imposed by DRM. Verified users may be given the same digital data with fewer or no restrictions imposed by DRM.

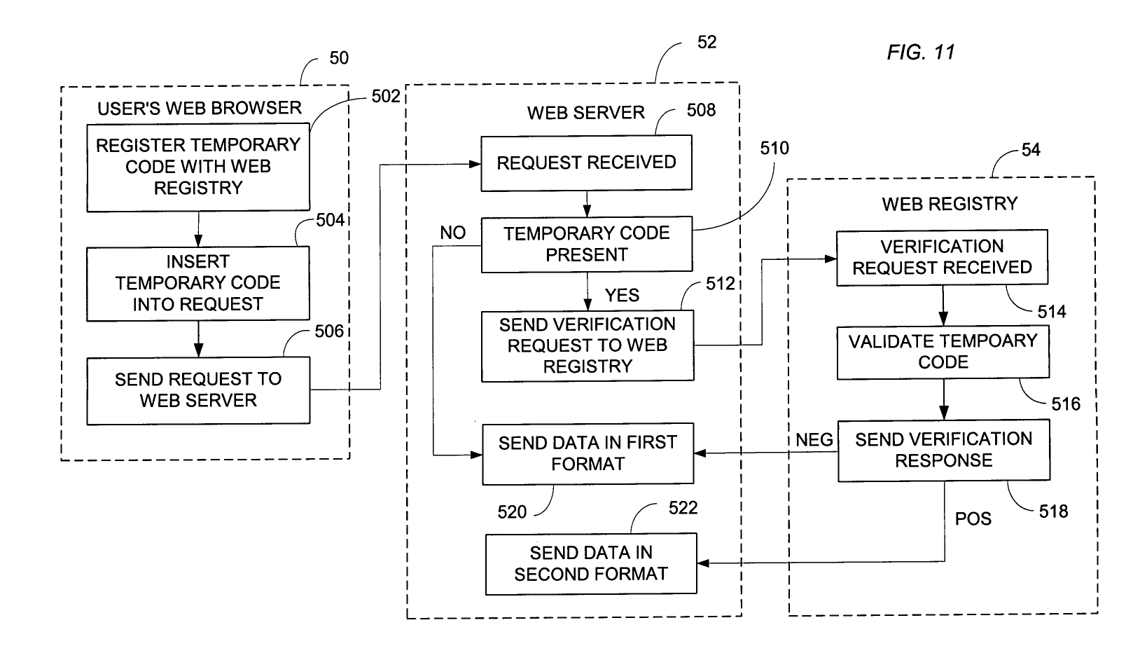

FIG. 11 illustrates a communication system that allows web servers to provide information in a convenient form to typical web users while preventing data mining or harvesting of information by spammers or other unfavored users. The users computer 50 includes a web browsing application that is programmed to generate temporary codes and register the temporary codes with a web registry 54 as previously described. The temporary code may be valid for only a limited number of requests, or valid for the session, or for a limited time period to prevent the temporary code from being useful to a spammer. The user's web browsing application inserts the temporary code into a request (block 504) and sends the request to a web server (block 506). The request is received by the web server 52 (block 508). The web server 52 checks for a temporary code in the request (block 510). If a temporary code is present, the web server 52 sends a verification request to the web registry 54 (block 512). The web registry 54 receives the verification request from the web server 52 (block 514), validates the temporary code (block 516), and sends a verification response to the web server 52 (block 518). When the web server 52 receives the verification response from the web registry 54, it sends the requested data to the user's web browsing application (block 520, 522). The data is sent in a format depending upon the verification response. If the verification response is negative, the data is sent in a first format (block 520). If the verification response is positive, the data is sent in a second format (block 522). For example, if the web server 52 stores web pages containing email addresses, the web server may send a web page containing the email address as a graphic if the verification response is negative, and send a web page containing the email address as normal text with an active link if the verification response is positive. If the request from the user's web browsing application does not include a temporary code, the request would be treated as an unverified request. This allows backward compatibility with web browsers that do not provide a temporary code.

The foregoing description describes a number of techniques that may be implemented to combat spam. The methods described may be used in a variety of different combinations, or may be implemented individually.

1. A method of sending electronic mail messages comprising:
inserting a temporary code into an outgoing electronic mail message from a sender to a designated recipient; and
registering the temporary code with a trusted mail registry that provides verification services.

2. The method of claim 1 wherein registering the temporary code comprises sending to the trusted mail registry a registration message containing account information identifying the sender, a master code of the sender, and the temporary code.

3. A method of handling electronic mail messages comprising:
receiving an electronic mail message containing a temporary code;
temporarily storing the electronic mail message;
sending a registration query containing the temporary code to a trusted mail registry; and
processing the electronic mail message based on the response from the trusted mail registry.

4. The method of claim 3 wherein processing the electronic mail message based on the response from the trusted mail registry comprises forwarding the electronic mail message if a positive response is received from the mail registry.

5. The method of claim 3 wherein processing the electronic mail message based on the response from the trusted mail registry comprises deleting the electronic mail message if a negative response is received from the mail registry.

6. The method of claim 3 wherein processing the electronic mail message based on the response from the trusted mail registry comprises sending a challenge to the sender of the electronic mail message if a negative response is received from the mail registry, and processing the electronic mail message based on the response to the challenge by the sender.

7. The method of claim 3 wherein processing the electronic mail message based on the response from the trusted mail registry comprises assigning a score to the electronic mail message and forwarding the electronic mail message to the designated recipient if the electronic mail message obtains a qualifying score.

8. The method of claim 7 wherein processing the electronic mail message based on the response from the trusted mail registry further comprises sending a challenge to the sender of the electronic mail message if the electronic mail message does not obtain a qualifying score, and processing the electronic mail message based on the response to the challenge by the sender.

9. The method of claim 8 wherein processing the electronic mail message based on the response from the trusted mail registry further comprises deleting the electronic mail message if it receives a disqualifying score.

10. An electronic mail system comprising:
a computer having a processor and a memory;
a mail application stored in memory and executed by said processor, said mail application including code to:
insert a temporary code into an outgoing electronic mail message from a sender to a designated recipient; and
register the temporary code with a trusted mail registry that provides verification services.

11. The electronic mail system of claim 10 wherein the mail application is one of a mail server application and a mail client application.

12. An electronic mail system for processing electronic mail messages comprising:
a computer having a processor and a memory;
a mail server application stored in memory and executed by said processor, said mail server application including code to:
receive an electronic mail message containing a temporary code;
temporarily store the electronic mail message;
send a registration query containing the temporary code to a trusted mail registry; and
process the electronic mail message based on the response from the trusted mail registry.

13. The electronic mail system of claim 12 wherein the code to process the electronic mail message comprises code to forward the electronic mail message if a positive response is received from the mail registry.

14. The electronic mail system of claim 12 wherein the code to process the electronic mail message comprises code to delete the electronic mail message if a negative response is received from the mail registry.

15. The electronic mail system of claim 12 wherein the code to process the electronic mail message comprises code to send a challenge to the sender of the electronic mail message if a negative response is received from the mail registry, and to process the electronic mail message based on the response to the challenge by the sender.

16. The electronic mail system of claim 12 wherein the code to process the electronic mail message comprises code to assign a score to the electronic mail message and to forward the electronic mail message to the designated recipient if the electronic mail message obtains a qualifying score.

17. The electronic mail system of claim 16 wherein the code to process the electronic mail message comprises code to send a challenge to the sender of the electronic mail message if the electronic mail message does not obtain a qualifying score, and to process the electronic mail message based on the response to the challenge by the sender.

18. The electronic mail system of claim 17 wherein the code to process the electronic mail message further comprises code to delete the electronic mail message if it receives a disqualifying score.

19. A web browsing device comprising:
a computer having a processor and a memory;
a web browsing application stored in memory and executed by said processor, said web browsing application including code to:
insert a temporary code into a data request;
send the data request to a web server; and
register the temporary code with a trusted web registry that provides verification services.

20. A method of web browsing comprising:
inserting a temporary code into a data request;
sending the data request to a web server; and
registering the temporary code with a trusted web registry that provides verification services.

21. A web server comprising:
a computer having a processor and a memory;
a server application stored in memory and executed by said processor, said server application including code to:
receive a data request from a web browser containing a temporary code;
send a verification query containing the temporary code to a trusted web registry; and
process the data request based on the response from the trusted web registry.

22. The web server of claim 21 wherein the code to process the code to process the data request comprises code to:
send data to the web browser in a first format if the response to the verification request is negative; and
send data to the web browser in a second format if the response to the verification request is positive.

23. A method of using a web server to provide data to users comprising:
receiving a data request from a web browser containing a temporary code;
sending a verification query containing the temporary code to a trusted web registry; and
processing the data request based on the response from the trusted web registry.

24. The method of claim 23 wherein processing the data request based on the response from the trusted web registry comprises:

25. A web registry comprising:
a computer having a processor and a memory;
a server application stored in memory and executed by said processor, said server application including code to:
receive registration requests containing a temporary codes and account information from a web browsing applications;
store the temporary codes and associated account information in a registry database;
receive verification requests from containing temporary codes and account information from web server applications;
authenticate the temporary codes; and
sending a verification response to the web server application.

26. The web registry of claim 25 wherein the code to authenticate the temporary codes comprises code to:
retrieve the temporary code in the database that is associated with the account information contained in the verification request; and
compare the retrieved temporary code with the temporary code contained in the verification request.

27. A mail application stored in a computer readable medium comprising code to:
insert a temporary code into an outgoing electronic mail message from a sender to a designated recipient; and
register the temporary code with a trusted mail registry that provides verification services.

28. A mail server application stored in a computer readable medium comprising code to:
receive an electronic mail message containing a temporary code;
temporarily store the electronic mail message;
send a registration query containing the temporary code to a trusted mail registry; and
process the electronic mail message based on the response from the trusted mail registry.

29. The mail server application of claim 28 wherein the code to process the electronic mail message comprises code to forward the electronic mail message if a positive response is received from the mail registry.

30. The mail server application of claim 28 wherein the code to process the electronic mail message comprises code to delete the electronic mail message if a negative response is received from the mail registry.

31. The mail server application of claim 28 wherein the code to process the electronic mail message comprises code to send a challenge to the sender of the electronic mail message if a negative response is received from the mail registry, and to process the electronic mail message based on the response to the challenge by the sender.

32. The mail server application of claim 28 wherein the code to process the electronic mail message comprises code to assign a score to the electronic mail message and to forward the electronic mail message to the designated recipient if the electronic mail message obtains a qualifying score.

33. The mail server application of claim 32 wherein the code to process the electronic mail message comprises code to send a challenge to the sender of the electronic mail message if the electronic mail message does not obtain a qualifying score, and to process the electronic mail message based on the response to the challenge by the sender.

34. The mail server application of claim 33 wherein the code to process the electronic mail message further comprises code to delete the electronic mail message if it receives a disqualifying score.

35. A web browsing application stored in computer-readable memory comprising:
code to insert a temporary code into a data request sent to a web server;
code to send the data request to a web server; and
code to register the temporary code with a trusted web registry that provides verification services.

36. A web server application stored in a computer readable medium comprising code to:
receive a data request from a web browser containing a temporary code;
send a verification query containing the temporary code to a trusted web registry; and
process the data request based on the response from the trusted web registry.

37. The web server application of claim 36 wherein the code to process the data request comprises code to:
send data to the web browser in a first format if the response to the verification request is negative; and
send data to the web browser in a second format if the response to the verification request is positive.
